(19) United States
(12) Patent Application Publication
(10) Pub. No.: US 2016/0336846 A1
(43) Pub. Date: Nov. 17, 2016

(54) INDUCTANCE DEVICE FOR PCB MOUNTING AND INVERTER WITH PCB MOUNTED INDUCTANCE DEVICE

(71) Applicant: SMA Solar Technology AG, Niestetal (DE)

(72) Inventors: Mariusz Walczak, Krakow (PL); Artur Mulawa, Bibice (PL); Marek S. Rylko, Bielsko-Biala (PL); Dorota Kusmierczyk, Krakow (PL)

(21) Appl. No.: 15/151,878

(22) Filed: May 11, 2016

(30) Foreign Application Priority Data
May 13, 2015 (DE) 102015107605.5

(51) Int. Cl. H02M 1/12; H01F 27/28; H02M 7/42; H01F 27/06

(52) U.S. Cl. CPC H02M 1/126; H01F 27/06; H01F 27/2828; H02M 7/42

(57) ABSTRACT

The disclosure relates to an inductance device for mounting on a printed circuit board including a substantially flat tray and a choke, the choke being mounted on an upper side of the tray and including a core and at least two wound around the core. The wires of the at least two coils comprise end segments that extend through the tray and terminate on a lower side of the tray opposite to the upper side of the tray. The tray includes notches for guiding the end segments through the tray and latches for fixing the end segments of the wires within the notches. The disclosures further relates to an inverter including an inductance device.

### CROSS REFERENCE TO RELATED APPLICATIONS

This application claims priority to German Patent Application number 10 2015 107 605.5, filed on May 13, 2015, and is hereby incorporated by reference in its entirety.

### FIELD

The present disclosure relates to an inductance device for mounting on a printed circuit board (PCB) comprising a tray for carrying a choke with at least two coils. The disclosure further relates to an inverter comprising an inductance device mounted on a PCB.

### BACKGROUND

An inductance device, in particular a choke, may be mounted on a printed circuit board (PCB) of an electrical or electronic device, e.g. a power converter, using surface mount technology (SMT) or through hole technology (THT). For this purpose, electrical connections of the inductance device comprise leads on the device which are inserted into holes in the PCB and soldered to soldering pads on the PCB.

In case of a choke, the inductance device comprises a number of coils wound around a core. Each coil comprises a wire with two end segments which are to be connected to designated connection points on a PCB. Depending on the application, a choke may comprise a significant total number of coils, e.g. six coils for a three phase common mode current choke for supressing common mode currents at the output of a three phase inverter, and a corresponding number of end segments, e.g. 12 end segments in case of said three phase common mode choke.

In order to facilitate mounting of such inductance device on a PCB, the inductance device may comprise a substantially flat tray which carries the choke itself on a top side of the tray and specifies the positions of the electrical connections of the inductance device on a bottom side of the tray, i.e. the positions of the end segments of the coils. For this purpose the tray may comprise guiding means to guide the end segments of the wires through the tray from the top side to the bottom side. Usually such guiding means are simply holes in the tray where the wire is running through.

DE10200500634A1 discloses an inductance device comprising a choke fixed on a mounting plate. The mounting plate comprises openings for receiving winding ends for maintaining a given modular dimension of the inductance device.

For assembly of an inductance device comprising a tray with said guiding means, the choke is created by winding the required number of coils respective to the application on the core. The choke is then fitted onto the tray to form the inductance device, and the inductance device is mounted on the PCB either by surface mount technology for a low current component or by through hole technology for a high current component.

A laborious part of such assembly process is the fitting of the choke onto the tray. The tray typically has holes that the wires are led through in order to provide a stable pinout geometry of the electrical connections. If a number of wires are to be guided through the tray there is additional complexity during the assembly which requires special attention. In particular, if the choke is designed for high power application and comprises correspondingly thick wires, it may be cumbersome to simultaneously align end segments of a number of wires with the guiding means of the tray before and during fitting of the choke onto the tray.

As an alternative to holes in the tray, the guiding means may comprise notches in the lateral sides of the tray which may additionally comprise clamping means. In this case, the choke is firstly fitted onto the tray and the wires are latched into the notches in a subsequent step.

DE102004037844A1 discloses an inductance device comprising a coil former with a winding form and a base comprising outwardly open grooves. Wires may be wound onto the winding form to form coils. Ends of the wires are placed in the grooves of the base and optionally snapping into the grooves if the grooves are narrowed towards the outside of the base.

Inductance devices comprising such notches to fix the end segments of the wires can usually only be used for wires of small diameter while large diameter wires are guided through holes in the tray. The additional step of shaping the wire in order to fit into the guiding means introduces mechanical stress that may produce reactive force, in particular during operation of the inductance device, such that the tray must provide sufficient ruggedness to fix the end segments of the wires in the desired positions. The bigger the wire diameter the higher reactive force it will produce and thus the stronger the tray has to be.

In some known solutions the end segments of the wires are fixed to the tray with glue that may be difficult to handle and to stabilize, which bears the additional risk of glue spillage on the inductance device, and further increases assembly time and effort.

DE2047901A1 discloses an inductance device comprising a choke mounted on a coil carrier. The coil carrier comprises notches. End segments of a wire of a winding of a coil mounted on the coil carrier are guided through channel-like notches at the outside of the coil carrier and may be fixed within said notches by gluing or by plastic deformation of lugs forming the channel-like notch.

In view of the state of the art, there is still a need for an inductance device for a power converter which is easy to assemble and which comprises a sufficient mechanical stability with an optimum material usage, in particular an inductance device with an substantially reduced assembly time which is hence more cost effective as compared to devices known from the state of the art.

### SUMMARY

An inductance device for mounting on a printed circuit board comprises a substantially flat tray and a choke. The choke is mounted on an upper side of the tray and comprises a core and at least two coils wound around the core. Wires of the at least two coils comprise end segments that extend through the tray and terminate on a lower side of the tray opposite to the upper side of the tray. The tray further comprises notches configured to guide the end segments through the tray.

An inductance device according to the disclosure further comprises latches configured to fix the end segments of the wires within the notches. Using these latches, the end segments of the wires are securely fixed within the notches after the wires have been placed within the notches, and manufacturing is eased significantly while at the same time mechanical properties of the inductance device are improved, in particular in terms of reduced mechanical stress to the wires of the windings.

The latches may be formed as separate elements and attached to the tray during assembly. Such latches may be pre-fabricated and held in stock for mass-production of inductance devices according to the disclosure having a variety of different configurations in terms of the number of coils and the modular dimensions of the inductance devices.

Alternatively, the latches may be formed as parts of the tray which are pivotably connected to the tray and pivoted onto the notches during assembly of the inductance device. If the latches are made as parts of the tray, there is no need to feed the latches to the tray during assembly of the inductance device such that assembly is even more simplified.

An inductance device according to the disclosure further comprises pairs of end segments fixed by common latches wherein the pairs of end segments are placed in pairs of notches and fixed by common latches. In comparison to a conventional setup, fewer latches are needed to secure the end segments in the notches pairwise, and the end segments of an individual pair of end segments are placed apart from another within a pair of notches such that the end segments are inherently electrically insulated against each other. Furthermore, the pairs of end segments may be placed on opposite lateral sides of the tray such that a symmetrical wiring configuration may be achieved. A common latch may be configured to fix further individual end segments in further notches or further pairs of end segments in further pairs of notches, respectively.

An Inductance device according to the disclosure further comprises a choke that comprises further coils comprising further wires, wherein further end segments of the further wires run through holes in the tray and are terminated on the lower side of the tray. Such holes for guiding the further end segments through the tray may be placed at arbitrary positions on the tray such that the available area under tray is facilitated in an optimal way.

In an embodiment, the choke of the inductance device comprises a total of six coils, each of the coils comprising a wire with two end segments. A first pair of end segments and a second pair of end segments run through holes on opposite sides of the tray besides the choke, and third to sixth pairs of end segments are placed in respective pairs of notches arranged on opposite lateral side of the tray besides the choke. The third to sixth pairs of end segments may then be fixed pairwise by common latches.

Such inductance device comprising a choke with six coils may be configured as a filter device for suppressing common mode currents in a three phase power line, e.g. at the output of a three phase power converter like an inverter. Compared to conventional setups comprising a tray with holes as guiding means for the end segments, the assembly of an inductance device according to the disclosure is significantly simplified since only four of the twelve end segments have to be placed accurately above the corresponding holes such that they can be pushed through the holes simultaneously when moving the choke towards the tray. The other eight end segments may be placed at some lateral position and can be fixed using the latches in a separate step after the choke has been fixed on the tray.

In a further embodiment, the core of the choke has a circular shape and comprises a spacer element arranged within the core. A rotational axis of the core is oriented parallel to the tray surface. The tray comprises locking means for locking the choke to the tray. The locking means extend substantially perpendicular to the tray surface and engage with the spacer element within the core.

An inverter according to the disclosure comprises an inductance device as described above. Such inverter may be assembled more cost-effective than an inverter comprising a conventional inductance device.

In an embodiment, the inverter comprises a three-phase output for connecting to a power supply grid, wherein an output filter is arranged at the output of the inverter, said output filter comprising an inductance device comprising a choke with six coils in an arrangement suitable for suppressing common mode currents. If said inductance comprises the features as described above, the manufacturing costs of the inverter are significantly reduced.

### BRIEF DESCRIPTION OF THE DRAWINGS

The disclosure may be better understood with reference to the following drawings. The components in the drawings are not necessarily to scale, emphasis instead being placed upon clearly illustrating the principles of the present disclosure. In the drawings, like reference numerals designate corresponding parts throughout the several views.

FIG. 1 shows an inductance device according to the disclosure in an exploded view, and

FIG. 2 shows an inductance device according to the disclosure after assembly.

### DETAILED DESCRIPTION

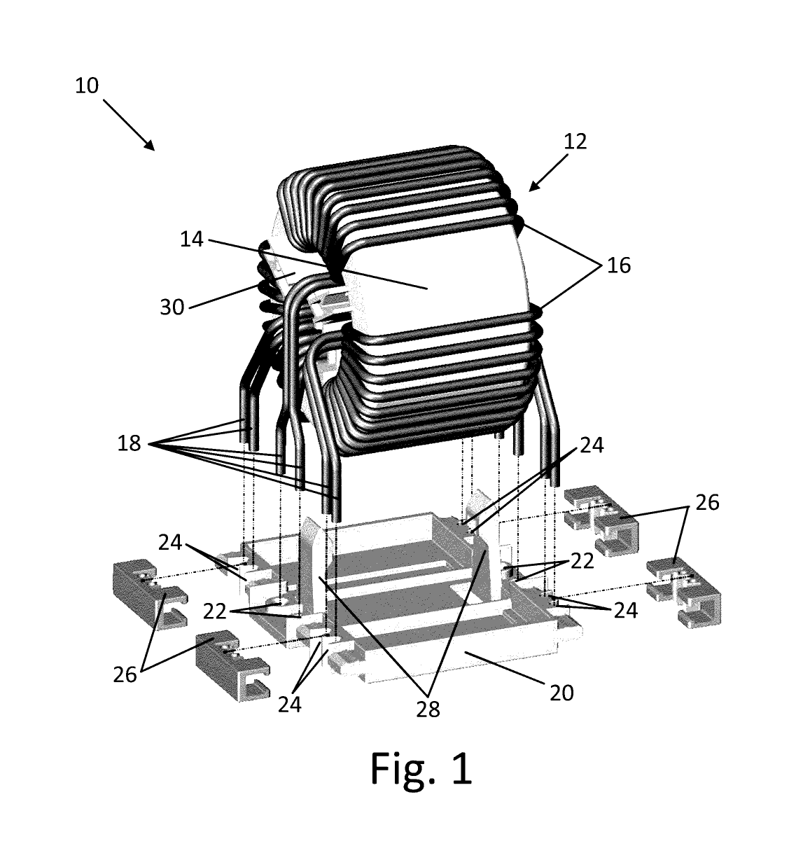

The inductance device 10 depicted in FIG. 1 comprises a choke 12 with a core 14 and coils 16 wound around the core 14. The coils 16 comprise end segments 18 for connection of the choke 12 to a superordinate circuit, e.g. an inverter output.

The inductance device 10 further comprises a tray 20 onto which the choke 12 is to be mounted. The tray 20 comprises holes 22 for guiding end segments 18 through the tray 20. During manufacturing, it has to be carefully assured that those end segments 18 that shall run through the holes 22 are aligned with the holes 22 such that these end segments 18 may be inserted in the holes 22 by moving the choke 12 towards the tray 20.

The tray 20 further comprises notches 24 arranged at lateral sides of the tray 20 for guiding end segments 18 through the tray 20. During manufacturing, it is sufficient to arrange those end segments 18 that shall run through the notches 24 in such a way that they do not hit the tray 20 when moving the choke 12 towards the tray. This may be easily achieved, e.g. by slightly bending or displacing these end segments 18 laterally outwards.

The inductance device 10 further comprises latches 26. In FIG. 1, these latches are shown as separate elements which may be moved onto the notches 24 and latched to the tray 20 after mounting the choke 12 onto the tray 20 such that those end segments 18 running through the notches 24 are fixed by the latches 26 within the notches 24. In an alternative embodiment, the latches 26 may be formed as parts of the tray 20 which are pivotably connected to the tray 20 and pivoted onto the notches 24 during assembly of the inductance device 10.

The tray 20 further comprises locking means 28, e.g. clips or catches, which extend substantially perpendicular to the surface of the tray 20. The choke 12 further comprises a spacer element 30 arranged within the core 14 of the choke 12. The spacer element 30 is used for, e.g., maintaining the circumferential positions of the coils 16 and guiding segments of wires of the coils 16 between the actual windings of the coils 16 and the end segments 18 through the core 14. During assembly of the inductance device 10, the choke 12 is moved towards the tray 20. As soon as the choke 12 reaches its designated position with respect to the tray 20, the locking means 28 latch or clip to the spacer element 30 such that the choke 12 is securely fixed onto the tray 20.

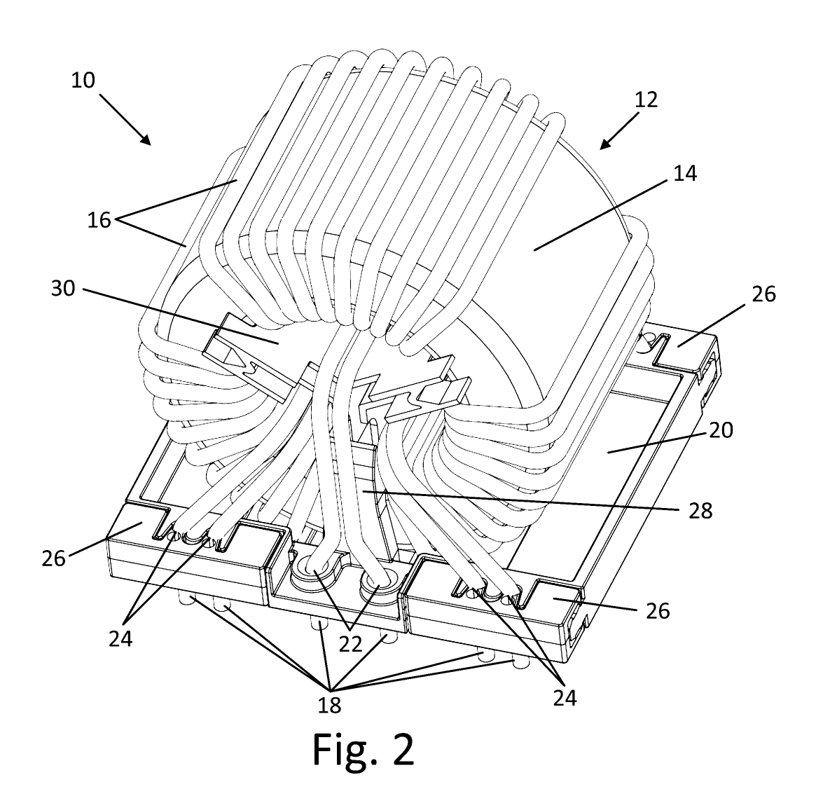

FIG. 2 shows an inductance device according to the disclosure after assembly. The end segments 18 of the coils 16 are guided through the tray 20 either by the holes 22 or by the notches 24. Those end segments 18 that run through the notches 24 are fixed by the latches 26 such that these end segments 18 are securely held at their designated position. The end segments 18 extend into the area below the tray 20 with a fixed spacing, i.e. comprising a predetermined modular dimension, such that the inductance device 10 may be easily mounted onto a printed circuit board comprising holes or soldering points with an identical modular dimension.

Many variations and modifications may be made to the preferred embodiments of the disclosure without departing substantially from the spirit and principles of the disclosure. All such modifications and variations are intended to be included herein within the scope of the present disclosure, as defined by the following claims. In particular, preferred further developments of the disclosure result from the claims, the description and the drawings. Advantages of features and of combinations of several features mentioned in the introduction of the description are only examples and may come into effect alternatively or cumulatively, without the necessity that the advantages have to be achieved by embodiments of the disclosure. The combination of features of different embodiments of the disclosure and of features of different claims is also possible and is encouraged herewith. This also applies to such features which are depicted in separate drawings or mentioned in their description.

1. An inductance device for mounting on a printed circuit board, comprising:
a substantially flat tray; and
a choke, the choke being mounted on an upper side of the tray and comprising a core and at least two coils wound around the core,
wherein wires of the at least two coils comprise end segments that extend through the tray and terminate on a lower side of the tray opposite to the upper side of the tray, and
wherein the tray comprises notches configured to guide the end segments through the tray and latches configured to fix the end segments of the wires within the notches.

2. The inductance device according to claim 1, wherein the latches comprise elements separate from the tray, or comprise elements that form part of the tray that are pivotably connected to the tray.

3. The inductance device according to claim 1, wherein pairs of end segments are fixed by common latches.

4. The inductance device according to claim 1, wherein pairs of end segments are placed in pairs of notches and fixed by common latches.

5. The inductance device according to claim 3, wherein the pairs of end segments are placed on opposite lateral sides of the tray.

6. The inductance device according to claim 1, wherein the choke comprises further coils comprising further wires, wherein further end segments of the further wires run through holes in the tray and are terminated on the lower side of the tray.

7. The inductance device according to claim 1, wherein the choke comprises six coils, each of the coils comprising a wire with two end segments, wherein a first pair of end segments and a second pair of end segments run through holes on opposite sides of the tray besides the choke, and wherein third to sixth pairs of end segments are placed in respective pairs of notches arranged on opposite lateral sides of the tray besides the choke and are fixed pairwise by common latches.

8. The inductance device according to claim 1, wherein the core has a circular shape and comprises a spacer element arranged within the core, wherein a rotational axis of the core is oriented parallel to the tray surface, and wherein the tray comprises a locking mechanism configured to lock the choke to the tray, wherein the locking mechanism extends substantially perpendicular to the surface of the tray and engages with the spacer element.

9. An inverter comprising an inductance device, the inductance device comprising:
a substantially flat tray; and
a choke, the choke being mounted on an upper side of the tray and comprising a core and at least two coils wound around the core,
wherein wires of the at least two coils comprise end segments that extend through the tray and terminate on a lower side of the tray opposite to the upper side of the tray, and
wherein the tray comprises notches configured to guide the end segments through the tray and latches configured to fix the end segments of the wires within the notches.

10. An inverter comprising a three-phase output for connecting the inverter to a power supply grid, wherein an output filter for suppressing common mode currents is arranged at the output of the inverter, said output filter comprising an inductance device, the inductance device comprising:
a substantially flat tray; and
a choke, the choke being mounted on an upper side of the tray and comprising a core and at least two coils wound around the core,
wherein wires of the at least two coils comprise end segments that extend through the tray and terminate on a lower side of the tray opposite to the upper side of the tray,
wherein the tray comprises notches configured to guide the end segments through the tray and latches configured to fix the end segments of the wires within the notches,
wherein the choke comprises six coils, each of the coils comprising a wire with two end segments, wherein a first pair of end segments and a second pair of end segments run through holes on opposite sides of the tray besides the choke, and
wherein third to sixth pairs of end segments are placed in respective pairs of notches arranged on opposite lateral sides of the tray besides the choke and are fixed pairwise by common latches.
